(19) United States
(12) Patent Application Publication
(10) Pub. No.: US 2020/0373611 A1
(43) Pub. Date: Nov. 26, 2020

(54) LITHIUM-ION SECONDARY BATTERY

(71) Applicant: MURATA MANUFACTURING CO., LTD., Kyoto (JP)

(72) Inventors: Masahiro MIYAMOTO, Kyoto (JP); Shinichi KATAYAMA, Kyoto (JP); Aki TANABE, Kyoto (JP)

(21) Appl. No.: 16/987,944

(22) Filed: Aug. 7, 2020

Related U.S. Application Data
(63) Continuation of application No. PCT/JP2019/004402, filed on Feb. 7, 2019.

(30) Foreign Application Priority Data
Feb. 9, 2018 (JP) 2018-021656

(51) Int. Cl. H01M 10/0525; H01M 4/525; H01M 10/0567; H01M 2/16; H01M 10/04; H01M 10/0585

(52) U.S. Cl. CPC H01M 10/0525; H01M 4/525; H01M 10/0567; H01M 2004/028; H01M 2/1653; H01M 10/0422; H01M 10/0585; H01M 2/1686

(57) ABSTRACT

A lithium-ion secondary battery includes a positive electrode, a negative electrode, and an electrolytic solution. The positive electrode includes a positive electrode active material. The positive electrode active material includes lithium (Li) and fluorine (F). The electrolytic solution includes a dioxane compound. A content of the dioxane compound is from 0.1 wt % to 2.0 wt %.

### CROSS REFERENCE TO RELATED APPLICATIONS

The present application is a continuation of PCT patent application no. PCT/JP2019/004402, filed on Feb. 7, 2019, and claims priority to the Japanese patent application no. JP2018-021656 filed on Feb. 9, 2018, the entire contents of which are being incorporated herein by reference.

### BACKGROUND

The present technology generally relates to a lithium-ion secondary battery including a positive electrode, a negative electrode, and an electrolytic solution.

Various electronic devices such as mobile phones have been widely used. Such wide spread use has invoked a need for a smaller size, a lighter weight, and a longer life of the electronic devices. To address the need, a lithium-ion secondary battery, which is smaller in size and lighter in weight and allows for a higher energy density, is under development as a power source.

A lithium-ion secondary battery includes: a positive electrode; a negative electrode; and an electrolytic solution for the lithium-ion secondary battery. A configuration of the electrolytic solution greatly influences battery characteristics. Accordingly, various considerations have been given to the configuration of the electrolytic solution.

Specifically, to improve a charged storage characteristic of a lithium-ion secondary battery under a high positive electrode potential condition, 1,3-dioxane is used as an additive of an electrolytic solution.

### SUMMARY

The present technology generally relates to a lithium-ion secondary battery including a positive electrode, a negative electrode, and an electrolytic solution.

Electronic devices, on which a lithium-ion secondary battery is to be mounted, are increasingly gaining higher performance and more functions, causing more frequent use of the electronic devices and expanding a use environment of the electronic devices. Accordingly, there is still room for improvement in terms of battery characteristics of the lithium-ion secondary battery.

The technology has been made in view of such an issue and it is an object of the technology to provide a lithium-ion secondary battery that makes it possible to achieve a superior battery characteristic.

According to an embodiment of the present technology, a lithium-ion secondary battery is provided. The lithium-ion secondary battery includes a positive electrode, a negative electrode, and an electrolytic solution. The positive electrode includes a positive electrode active material. The positive electrode active material includes lithium (Li) and fluorine (F). The electrolytic solution includes a dioxane compound represented by a chemical formula (1). A content of the dioxane compound is from 0.1 wt % to 2.0 wt %.

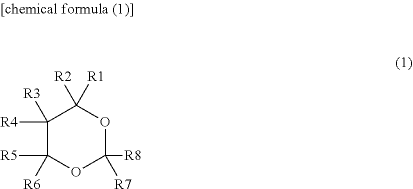

(Where each of R1 to R8 represents at least one of a hydrogen group and a monovalent hydrocarbon group.)

According to the lithium-ion secondary battery of the present technology, the positive electrode active material includes lithium and fluorine as the constituent elements, and the electrolytic solution includes a predetermined amount of the dioxane compound. Accordingly, it is possible to achieve a superior battery characteristic.

It should be understood that effects of the technology are not necessarily limited to those described above and may include any of a series of effects described below in relation to the technology.

### BRIEF DESCRIPTION OF THE FIGURES

FIG. 1 is a sectional view of a configuration of a lithium-ion secondary battery (cylindrical type) according to an embodiment of the technology.

FIG. 2 is an enlarged sectional view of a configuration of a main part of the lithium-ion secondary battery illustrated in FIG. 1.

FIG. 3 is a perspective view of a configuration of another lithium-ion secondary battery (laminated-film type) according to an embodiment of the technology.

FIG. 4 is a sectional view of a configuration of a main part of the lithium-ion secondary battery illustrated in FIG. 3.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a lithium-ion secondary battery according to an embodiment of the technology.

The lithium-ion secondary battery described below obtains a battery capacity by utilizing, for example, a lithium insertion phenomenon and a lithium extraction phenomenon. The battery capacity is, in other words, a capacity of a negative electrode 22 which will be described later.

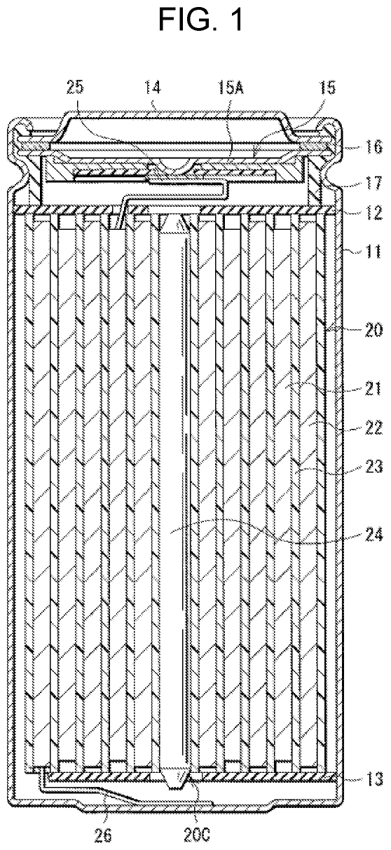

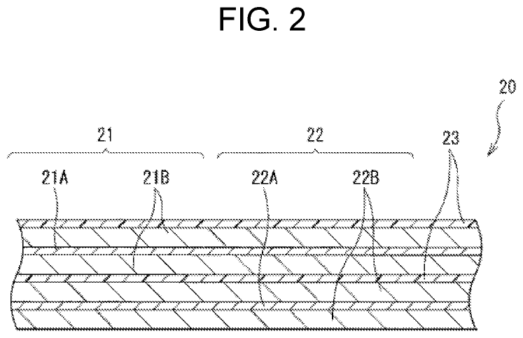

FIG. 1 illustrates a sectional configuration of the lithium-ion secondary battery. FIG. 2 illustrates an enlarged sectional configuration of a main part, i.e., a wound electrode body 20, of the lithium-ion secondary battery illustrated in FIG. 1. It should be understood that FIG. 2 illustrates only a part of the wound electrode body 20.

The lithium ion secondary battery is, for example, as illustrated in FIG. 1, a cylindrical lithium ion secondary battery provided with a battery can 11 that has a cylindrical shape and contains the wound electrode body 20. The wound electrode body 20 serves as a battery device.

Specifically, the lithium-ion secondary battery includes, for example, a pair of insulating plates 12 and 13 and the wound electrode body 20 that are provided in the battery can 11. The wound electrode body 20 includes, for example, a wound body in which a positive electrode 21 and the negative electrode 22 are stacked with a separator 23 therebetween and are wound. The wound electrode body 20 is impregnated with an electrolytic solution, for example. The electrolytic solution is a liquid electrolyte, for example.

The battery can 11 has, for example, a hollow structure having a closed end and an open end. The battery can 11 includes one or more materials including, without limitation, iron (Fe), aluminum (Al), and alloys thereof. For example, the battery can 11 has a surface that may be plated with a material such as nickel (Ni). The insulating plate 12 and the insulating plate 13 are so disposed as to, for example, interpose the wound electrode body 20 therebetween. The insulating plate 12 and the insulating plate 13 each extend, for example, in a direction intersecting a wound peripheral surface of the wound electrode body 20.

For example, a battery cover 14, a safety valve mechanism 15, and a positive temperature coefficient device (PTC device) 16 are crimped at the open end of the battery can 11 by means of a gasket 17, thereby sealing the open end of the battery can 11. The battery cover 14 includes a material similar to a material forming the battery can 11, for example. The safety valve mechanism 15 and the positive temperature coefficient device 16 are each disposed on an inner side of the battery cover 14. The safety valve mechanism 15 is electrically coupled to the battery cover 14 via the positive temperature coefficient device 16. For example, when an internal pressure of the battery can 11 reaches a certain level or higher as a result of causes including, without limitation, internal short circuit and heating from the outside, a disk plate 15A inverts in the safety valve mechanism 15, thereby cutting off the electrical coupling between the battery cover 14 and the wound electrode body 20. The resistance of the positive temperature coefficient device 16 increases with a rise in temperature in order to prevent abnormal heat generation resulting from a large current. The gasket 17 includes, for example, an insulating material. The gasket 17 may have a surface on which a material such as asphalt is applied, for example.

For example, a center pin 24 is inserted in a space 20C provided at the winding center of the wound electrode body 20. Note, however, that the center pin 24 may be eliminated. A positive electrode lead 25 is coupled to the positive electrode 21. The positive electrode lead 25 includes one or more electrically conductive materials such as aluminum. The positive electrode lead 25 is electrically coupled to the battery cover 14 via the safety valve mechanism 15, for example. A negative electrode lead 26 is coupled to the negative electrode 22. The negative electrode lead 26 includes one or more electrically conductive materials such as nickel. The negative electrode lead 26 is electrically coupled to the battery can 11, for example.

Referring to FIG. 2, the positive electrode 21 includes a positive electrode current collector 21A and two positive electrode active material layers 21B, for example. The positive electrode active material layer 21B is provided on each side of the positive electrode current collector 21A, for example. Note, however, that the positive electrode 21 may include only a single positive electrode active material layer 21B provided on one side of the positive electrode current collector 21A, in one example.

The positive electrode current collector 21A includes one or more electrically conductive materials, for example. Examples of the electrically conductive materials include aluminum, nickel, and stainless steel. The positive electrode current collector 21A may have a single layer or multiple layers.

The positive electrode active material layer 21B includes one or more positive electrode materials as a positive electrode active material. The positive electrode materials are materials into which lithium is insertable and from which lithium is extractable. The positive electrode active material layer 21B may further include one or more other materials including, without limitation, a positive electrode binder and a positive electrode conductor.

The positive electrode material includes a lithium-containing compound. This is because a high energy density is achievable. The term “lithium-containing compound” is a generic term for a compound that includes lithium as a constituent element.

Specifically, the positive electrode material includes a lithium-fluorine-containing compound as the lithium-containing compound. The term “lithium-fluorine-containing compound” is a generic term for a compound that includes lithium and fluorine as constituent elements.

A reason why the positive electrode material includes the lithium-fluorine-containing compound is that combined use of the lithium-fluorine-containing compound and a predetermined amount of a dioxane compound that is included in the electrolytic solution allows a film (a protective film) derived from the dioxane compound to be formed on a surface of the positive electrode 21, as will be described later. As a result, the electrolytic solution is less likely to be decomposed on the surface of the positive electrode 21, therefore improving chemical stability of the electrolytic solution.

In this case, a stable film is formed on the surface of the positive electrode 21 even if the lithium-ion secondary battery is stored under, in particular, a low-temperature environment, allowing the decomposition reaction of the electrolytic solution to be sufficiently reduced. Further, even if a high end-of-charge voltage is set upon charging of the lithium-ion secondary battery, a stable film is formed on the surface of the positive electrode 21, allowing the decomposition reaction of the electrolytic solution to be sufficiently reduced. The term “end-of-charge voltage” refers to an upper-limit charge voltage at the time of charging. The term “high end-of-charge voltage” refers to a positive electrode potential of 4.35 V or higher, preferably, 4.40 V or higher, versus a lithium reference electrode, for example. That is, in a case of using a carbon material such as graphite as the negative electrode active material, the positive electrode potential is 4.30 V or higher, preferably, 4.35 V or higher.

The advantages described above are special technical tendencies which are obtainable only in a case of using the lithium-fluorine-containing compound, in other words, in a case of using the lithium-containing compound including fluorine as a constituent element. Therefore, the advantages described above are not obtainable in a case of using the lithium-containing compound not including fluorine as a constituent element. The advantages described above are not obtainable in a case of using the lithium-containing compound including a halogen other than fluorine as a constituent element either. Examples of the “halogen other than fluorine” include chlorine (Cl).

The kind of lithium-fluorine-containing compound is not particularly limited as long as the lithium-fluorine-containing compound includes lithium and fluorine as constituent elements as described above. Specific examples of the lithium-fluorine-containing compound include a lithium-fluorine-containing composite oxide having an average composition represented by the following chemical formula (2). The lithium-fluorine-containing composite oxide is an oxide that includes lithium, fluorine, cobalt (Co), and one or more other elements (M) as constituent elements. This is because it is easier to allow a stable film derived from the dioxane compound to be formed on the surface of the positive electrode 21.

Li_{w}CoₓM_{y}O_{2-z}F_{z} (2)

### (Where:

M is at least one of titanium (Ti), vanadium (V), chromium (Cr), manganese (Mn), iron, nickel, copper (Cu), sodium (Na), magnesium (Mg), aluminum, silicon (Si), potassium (K), calcium (Ca), zinc (Zn), gallium (Ga), strontium (Sr), yttrium (Y), zirconium (Zr), niobium (Nb), molybdenum (Mo), barium (Ba), lanthanum (La), and tungsten (W); and w, x, y, and z satisfy 0.8<w<1.2, 0.9<x+y<1.1, 0≤y<0.1, and 0<z<0.05.)

In particular, it is preferable that the other element (M) be one or more of titanium, magnesium, aluminum, and zirconium. This is because it is further easier to allow the stable film derived from the dioxane compound to be formed on the surface of the positive electrode 21.

The kind of lithium-fluorine-containing compound is not particularly limited as long as the lithium-fluorine-containing compound is a compound having a structure represented by the chemical formula (2).

Fluorine included in the positive electrode active material (the lithium-fluorine-containing compound as the positive electrode material) is obviously fluorine included in the lithium-fluorine-containing compound as a constituent element. Therefore, fluorine described here does not refer to fluorine included, as a constituent element, in a component other than the positive electrode active material, nor does it refer to fluorine included in a side reaction product formed upon use of the lithium-ion secondary battery, i.e., upon charging and discharging of the lithium-ion secondary battery. The former fluorine is, for example but not limited to, fluorine included in a later-described electrolyte salt such as lithium hexafluorophosphate. The latter fluorine is, for example but not limited to, fluorine included in a reactant formed upon charging and discharging, such as lithium fluoride (LiF).

To confirm whether the positive electrode active material includes fluorine as a constituent element, the positive electrode active material may be analyzed by, for example, the following procedure through use of any analysis method.

First, the lithium-ion secondary battery is disassembled to thereby collect the positive electrode 21, following which the positive electrode active material layers 21B are separated from the positive electrode current collector 21A. Thereafter, the positive electrode active material layers 21B are put into an organic solvent, following which the organic solvent is stirred. The kind of organic solvent is not particularly limited as long as the organic solvent allows for dissolution of a soluble component such as the positive electrode binder. This allows the positive electrode active material layers 21B to be separated into an insoluble component such as the positive electrode active material and into the soluble component such as the positive electrode binder. As a result, the positive electrode active material is collected. Lastly, the positive electrode active material is analyzed by X-ray photoelectron spectroscopy (XPS) to thereby confirm whether the positive electrode active material includes fluorine as a constituent element.

To give an example, if the positive electrode active material (the lithium-fluorine-containing compound) includes fluorine and magnesium as constituent elements, an analysis peak derived from a Mg—F bond is detected in the vicinity of a binding energy of 306 eV. Magnesium is the other element (M). Accordingly, in a case where such an analysis peak is detected, it is possible to confirm that the positive electrode active material includes fluorine as a constituent element. In contrast, in a case where such an analysis peak is not detected, it is possible to confirm that the positive electrode active material does not include fluorine as a constituent element.

It should be understood that the positive electrode material may include one or more other lithium-containing compounds together with the above-described specific lithium-containing compound (the lithium-fluorine-containing compound).

Examples of the other lithium-containing compounds include a lithium-containing composite oxide and a lithium-containing phosphate compound. The term “lithium-containing composite oxide” is a generic term for an oxide that includes, as constituent elements, lithium and one or more other elements. The lithium-containing composite oxide has, for example, any of crystal structures including, without limitation, a layered rock-salt crystal structure and a spinel crystal structure. Note that the lithium-fluorine-containing compound described above is excluded from the lithium-containing composite oxide described here. The term “lithium-containing phosphate compound” is a generic term for a phosphate compound that includes, as constituent elements, lithium and one or more other elements. The lithium-containing phosphate compound has a crystal structure such as an olivine crystal structure.

The term “other elements” refer to elements other than lithium. In particular, it is preferable that the other elements belong to groups 2 to 15 in the long periodic table of elements, although the kinds of other elements are not particularly limited. This is because a higher voltage is obtainable. Specific examples of the other elements include nickel, cobalt, manganese, and iron.

Examples of the lithium-containing composite oxide having the layered rock-salt crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂. Examples of the lithium-containing composite oxide having the spinel crystal structure include LiMn₂O₄. Examples of the lithium-containing phosphate compound having the olivine crystal structure include LiFePO₄, LiMnPO₄, LiFe_{0.5}Mn_{0.5}PO₄, and LiFe_{0.3}Mn_{0.7}PO₄.

The positive electrode binder includes, for example, one or more materials including, without limitation, synthetic rubber and polymer compounds. Examples of the synthetic rubber include styrene-butadiene-based rubber, fluorine-based rubber, and ethylene propylene diene. Examples of the polymer compounds include polyvinylidene difluoride and polyimide.

The positive electrode conductor includes one or more electrically conductive materials such as a carbon material. Examples of the carbon material include graphite, carbon black, acetylene black, and Ketjen black. The positive electrode conductor may include a material such as a metal material or an electrically conductive polymer, as long as the positive electrode conductor includes an electrically conductive material.

As illustrated in FIG. 2, the negative electrode 22 includes a negative electrode current collector 22A and two negative electrode active material layers 22B, for example. The negative electrode active material layer 22B is provided on each side of the negative electrode current collector 22A, for example. Note, however, that the negative electrode 22 may include only a single negative electrode active material layer 22B provided on one side of the negative electrode current collector 22A, in one example.

The negative electrode current collector 22A includes one or more electrically conductive materials, for example. Examples of the electrically conductive materials include copper, aluminum, nickel, and stainless steel. The negative electrode current collector 22A may have a single layer or multiple layers.

It is preferable that the negative electrode current collector 22A have a surface roughened by a method such as electrolysis. This is because adherence of the negative electrode active material layer 22B with respect to the negative electrode current collector 22A is improved by utilizing a so-called anchor effect.

The negative electrode active material layer 22B includes one or more negative electrode materials as a negative electrode active material. The negative electrode materials are materials into which lithium is insertable and from which lithium is extractable. The negative electrode active material layer 22B may further include one or more other materials including, without limitation, a negative electrode binder and a negative electrode conductor.

To prevent unintentional precipitation of lithium metal on a surface of the negative electrode 22 during charging, it is preferable that a chargeable capacity of the negative electrode material be greater than a discharge capacity of the positive electrode 21. In other words, it is preferable that an electrochemical equivalent of the negative electrode material be greater than an electrochemical equivalent of the positive electrode 21.

Examples of the negative electrode material include a carbon material and a metal-based material, although the kind of negative electrode material is not particularly limited.

The term “carbon material” is a generic term for a material including carbon as a constituent element. This is because a high energy density is stably obtainable owing to the crystal structure of the carbon material which hardly varies upon insertion and extraction of lithium. This is also because electrical conductivity of the negative electrode active material layer 22B improves owing to the carbon material which also serves as a negative electrode conductor.

Examples of the carbon material include graphitizable carbon, non-graphitizable carbon, and graphite. It is preferable that the spacing of a (002) plane of the non-graphitizable carbon be equal to or greater than 0.37 nm, and the spacing of a (002) plane of the graphite be equal to or smaller than 0.34 nm.

More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is the result of firing or carbonizing a polymer compound such as phenol resin or furan resin at an appropriate temperature. Other than the above, the carbon material may be low-crystalline carbon subjected to heat treatment at a temperature of about 1000° C. or lower, or may be amorphous carbon, for example. The carbon material has a shape such as a fibrous shape, a spherical shape, a granular shape, or a scale-like shape.

The term “metal-based material” is a generic term for a material including, as constituent elements, one or more metal elements and metalloid elements. This is because a high energy density is obtainable.

The metal-based material may be a simple substance, an alloy, a compound, a mixture of two or more thereof, or a material including one or more phases thereof. Note that the term “alloy” encompasses not only a material including two or more metal elements but also a material including one or more metal elements and one or more metalloid elements. The term “alloy” may further include one or more non-metallic elements. The metal-based material has a state such as a solid solution, a eutectic (a eutectic mixture), an intermetallic compound, or a state including two or more thereof that coexist.

The metal element and the metalloid element are each able to form an alloy with lithium. Specific examples of the metal element and the metalloid element include magnesium, boron (B), aluminum, gallium, indium (In), silicon, germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt).

Among the above-described materials, silicon or tin is preferable, and silicon is more preferable. This is because a markedly high energy density is obtainable owing to superior lithium insertion capacity and superior lithium extraction capacity thereof.

The metal-based material may specifically be a simple substance of silicon, a silicon alloy, a silicon compound, a simple substance of tin, a tin alloy, a tin compound, a mixture of two or more thereof, or a material including one or more phases thereof. The “simple substance” described here merely refers to a simple substance in a general sense. The simple substance may therefore include a small amount of impurity, that is, does not necessarily have a purity of 100%.

The silicon alloy includes one or more elements including, without limitation, tin, nickel, copper, iron, cobalt, manganese, zinc, indium, silver, titanium, germanium, bismuth, antimony (Sb), and chromium as constituent elements other than silicon. The silicon compound includes one or more elements including, without limitation, carbon (C) and oxygen (O) as constituent elements other than silicon. The silicon compound may include, as constituent elements other than silicon, one or more of the series of constituent elements described in relation to the silicon alloy.

Examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiO, (where 0<v≤2), and LiSiO. Note, however, that a range of “v” may be 0.2<v<1.4, in one example.

The tin alloy includes one or more elements including, without limitation, silicon, nickel, copper, iron, cobalt, manganese, zinc, indium, silver, titanium, germanium, bismuth, antimony, and chromium as constituent elements other than tin. The tin compound includes one or more elements including, without limitation, carbon and oxygen as constituent elements other than tin. The tin compound may include, as constituent elements other than tin, one or more of the series of constituent elements described in relation to the tin alloy, for example.

Examples of the tin alloy and the tin compound include SnO_{w} (where 0<w≤2), SnSiO₃, LiSnO, and Mg₂Sn.

In particular, it is preferable that the negative electrode material include both the carbon material and the metal-based material for the following reason.

The metal-based material, in particular, the material including silicon or tin as a constituent element, has an advantage of a high theoretical capacity, on the other hand, the metal-based material, in particular, the material including silicon or tin as a constituent element, has an issue of easier and greater expansion and contraction upon charging and discharging. In contrast, the carbon material has an issue of a low theoretical capacity; on the other hand, the carbon material has an advantage in that it negligibly expands and contracts upon charging and discharging. Accordingly, combined use of the carbon material and the metal-based material allows for a high theoretical capacity, i.e., a high battery capacity, while reducing expansion and contraction of the negative electrode active material layer 22B upon charging and discharging.

Details of the negative electrode binder are similar to those of the positive electrode binder described above, for example. Details of the negative electrode conductor are similar to those of the negative electrode conductor described above, for example.

The negative electrode active material layer 22B is formed by one or more methods including a coating method, a vapor-phase method, a liquid-phase method, a thermal spraying method, and a firing (sintering) method, although the method of forming the negative electrode active material layer 22B is not particularly limited. For example, the coating method involves coating the negative electrode current collector 22A with a solution in which a mixture of materials including, without limitation, a particulate or powdered negative electrode active material and the negative electrode binder is dissolved or dispersed into a solvent such as an organic solvent. Examples of the vapor-phase method include a physical deposition method and a chemical deposition method. More specific examples of the vapor-phase method include a vacuum deposition method, a sputtering method, an ion plating method, a laser ablation method, a thermal chemical vapor deposition method, a chemical vapor deposition (CVD) method, and a plasma chemical vapor deposition method. Examples of the liquid-phase method include an electrolytic plating method and an electroless plating method. The thermal spraying method involves spraying a fused or semi-fused negative electrode active material onto the negative electrode current collector 22A. The firing method involves applying a solution onto the negative electrode current collector 22A by the coating method, followed by subjecting a film of the applied solution to heat treatment at a temperature higher than a melting point of a material such as the negative electrode binder, for example. More specific examples of the firing method include an atmosphere firing method, a reactive firing method, and a hot-press firing method.

As illustrated in FIG. 2, the separator 23 is interposed between the positive electrode 21 and the negative electrode 22, for example. The separator 23 allows lithium ions to pass therethrough while preventing short circuit resulting from contact of the positive electrode 21 and the negative electrode 22 with each other.

The separator 23 includes one or more porous films each including a material such as synthetic resin or ceramic, for example. The separator 23 may be a stacked film including two or more porous films that are stacked on each other, in one example. Examples of the synthetic resin include polytetrafluoroethylene, polypropylene, and polyethylene.

In particular, the separator 23 may include the above-described porous film and a polymer compound layer, for example. The porous film serves as a base layer. The polymer compound layer is provided on one side or on each side of the base layer, for example. This is because the separator 23 with such as configuration decreases the likelihood of deformation of the wound electrode body 20, owing to improved adherence of the separator 23 with respect to each of the positive electrode 21 and the negative electrode 22. This reduces a decomposition reaction of the electrolytic solution and also reduces leakage of the electrolytic solution with which the base layer is impregnated. Accordingly, this decreases the likelihood of an increase in resistance of the lithium-ion secondary battery even with repetitive charging and discharging and decreases the likelihood of swelling of the lithium-ion secondary battery as well.

The polymer compound layer includes one or more polymer compounds such as polyvinylidene difluoride. This is because such a polymer compound has superior physical strength and is electrochemically stable. For example, the polymer compound layer may include one or more insulating particles such as inorganic particles. This is to improve safety. Examples of the inorganic particles include aluminum oxide and aluminum nitride, although the kind of inorganic particles is not particularly limited.

The wound electrode body 20 is impregnated with the electrolytic solution, as described above. Accordingly, the separator 23, the positive electrode 21, and the negative electrode 22 are each impregnated with the electrolytic solution, for example.

The electrolytic solution includes one or more dioxane compounds represented by the following chemical formula (1). The content of the dioxane compound in the electrolytic solution is equal to or greater than 0.1 wt % and equal to or less than 2.0 wt %. The dioxane compound is any of: cyclic ether having an oxygen atom at each of position 1 and position 3 (1,3-dioxane, which is a six-membered ring); and a derivative thereof.

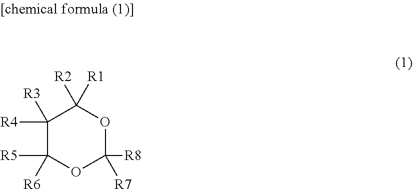

(Where each of R1 to R8 is one of a hydrogen group and a monovalent hydrocarbon group.)

A reason why the electrolytic solution includes a predetermined amount of the dioxane compound, i.e., the dioxane compound having a content that is equal to or greater than 0.1 wt % and equal to or less than 2.0 wt %, is that, in a case where the positive electrode 21 (the positive electrode active material) includes the lithium-fluorine-containing compound, a stable film derived from the dioxane compound is formed on the surface of the positive electrode 21 as described above, and the electrolytic solution is less likely to be decomposed on the surface of the positive electrode 21.

More specifically, even if the electrolytic solution includes the dioxane compound in a case where the positive electrode 21 includes the lithium-fluorine-containing compound, it is difficult to form the stable film on the surface of the positive electrode 21 unless the content of the dioxane compound in the electrolytic solution is appropriate, i.e., unless the content of the dioxane compound in the electrolytic solution is equal to or greater than 0.1 wt % and equal to or less than 2.0 wt %. In this case, the decomposition reaction of the electrolytic solution is not reduced sufficiently.

In contrast, in a case where: the positive electrode 21 includes the lithium-fluorine-containing compound; and the electrolytic solution includes an appropriate amount of the dioxane compound, a stable film is formed on the surface of the positive electrode 21. Accordingly, the decomposition reaction of the electrolytic solution is reduced sufficiently.

A possible reason why a stable film is thus formed on the surface of the positive electrode 21 is as described below. The positive electrode active material (the lithium-fluorine-containing compound) includes a fluorine atom having a high electron withdrawing effect. In addition, the dioxane compound includes a hydrocarbon group (—CR7R8-) having a high electron donating effect at position 2. In this case, a synergetic action of the fluorine atom having the electron withdrawing effect and the hydrocarbon group having the electron donating effect causes an existence probability of the dioxane compound on the surface of the positive electrode 21 to be higher than an existence probability of the dioxane compound at a location other than the surface of the positive electrode 21. Accordingly, it is more likely that the dioxane compound is present on the surface of the positive electrode 21 and in the vicinity thereof, and thus the film derived from the dioxane compound is more likely to be formed on the surface of the positive electrode 21.

In particular, it is preferable that the content of the dioxane compound in the electrolytic solution be equal to or greater than 1.0 wt % and equal to or less than 1.5 wt %. This is because a stable film is more likely to be formed on the surface of the positive electrode 21.

The kind of dioxane compound is not particularly limited as long as the dioxane compound has the structure represented by the formula (1). That is, the dioxane compound may be 1,3-dioxane, or may be a derivative of a 1,3-dioxane compound.

The term “monovalent hydrocarbon group” related to each of R1 to R8 is a generic term for a monovalent group including carbon and hydrogen (H). Accordingly, the monovalent hydrocarbon group may be: a straight-chain group; a branched group having one or more side chains; a cyclic group having one or more rings; or a bonded group including two or more thereof that are bonded to each other. The monovalent hydrocarbon group may include one or more carbon-carbon unsaturated bonds, or may include no carbon-carbon unsaturated bond. Examples of the carbon-carbon unsaturated bond include a carbon-carbon double bond and a carbon-carbon triple bond.

Specific examples of the monovalent hydrocarbon group include an alkyl group, an alkenyl group, an alkynyl group, a cycloalkyl group, an aryl group, and a bonded group. The term “bonded group” is a monovalent group including two or more of an alkyl group, an alkenyl group, an alkynyl group, a cycloalkyl group, and an aryl group that are bonded to each other.

The alkyl group has carbon number of, for example, 1 to 3, although the carbon number of the alkyl group is not particularly limited. The alkenyl group and the alkynyl group each have carbon number of, for example, 2 or 3, although the carbon number of each of the alkenyl group and the alkynyl group is not particularly limited. This is because the dissolubility and miscibility of the dioxane compound improve. Specific examples of the alkyl group include a methyl group, an ethyl group, and a propyl group. Specific examples of the alkenyl group include a vinyl group. Specific examples of the alkynyl group include an acetyl group.

The cycloalkyl group and the aryl group each have carbon number of, for example, 3 to 8, although the carbon number of each of the cycloalkyl group and the aryl group is not particularly limited. This is because the dissolubility and miscibility of the dioxane compound improve. Examples of the cycloalkyl group include a cyclopropyl group, a cyclobutyl group, a cyclopentyl group, and a cyclohexyl group. Examples of the aryl group include a phenyl group and a naphthyl group.

Examples of the dioxane compound include 1,3-dioxane, 4-methyl-1,3-dioxane, 4,5-dimethyl-1,3-dioxane, and 4,5,6-trimethyl-1,3-dioxane, although the kind of dioxane compound is not particularly limited.

In particular, it is preferable that the dioxane compound be 1,3-dioxane. This is because a stable film is more likely to be formed on the surface of the positive electrode 21.

The electrolytic solution may include one or more other materials in addition to the dioxane compound. Examples of the other materials include a solvent and an electrolyte salt, although the kinds of other materials are not particularly limited.

The solvent includes one or more non-aqueous solvents (organic solvents), for example. An electrolytic solution including the non-aqueous solvent is a so-called non-aqueous electrolytic solution. Note that the dioxane compound is excluded from the non-aqueous solvent described here.

Examples of the non-aqueous solvent include carbonate ester, chain carboxylate ester, lactone, and a nitrile (mononitrile) compound. This is because characteristics including, without limitation, a superior battery capacity, a superior cyclability characteristic, and a superior storage characteristic are achievable.

The carbonate ester includes cyclic carbonate ester, chain carbonate ester, or both, for example. Examples of the cyclic carbonate ester include ethylene carbonate, propylene carbonate, and butylene carbonate. Examples of the chain carbonate ester include dimethyl carbonate, diethyl carbonate, ethyl methyl carbonate, and methyl propyl carbonate. Examples of the chain carboxylate ester include methyl acetate, ethyl acetate, methyl propionate, ethyl propionate, propyl propionate, methyl butyrate, methyl isobutyrate, methyl trimethyl acetate, and ethyl trimethyl acetate. Examples of the lactone include γ-butyrolactone and γ-valerolactone. Examples of the nitrile compound include acetonitrile, methoxy acetonitrile, and 3-methoxy propionitrile.

Examples of the non-aqueous solvent may also include 1,2-dimethoxy ethane, tetrahydrofuran, 2-methyl tetrahydrofuran, tetrahydropyran, 1,3-dioxolane, 4-methyl-1,3-di oxolane, 1,4-dioxane, N,N-dimethyl formamide, N-methyl pyrrolidinone, N-methyl oxazolidinone, N,N′-dimethyl imidazolidinone, nitromethane, nitroethane, sulfolane, trimethyl phosphate, and dimethyl sulfoxide. This is because similar advantages are obtainable.

In particular, it is preferable that the non-aqueous solvent include carbonate ester. Specifically, it is more preferable that the non-aqueous solvent include one or more materials including, without limitation, ethylene carbonate, propylene carbonate, dimethyl carbonate, diethyl carbonate, and ethyl methyl carbonate. This is because characteristics including, without limitation, a higher battery capacity, a superior cyclability characteristic, and a superior storage characteristic are achievable.

More specifically, it is preferable that the carbonate ester include both the cyclic carbonate ester and the chain carbonate ester. In this case, it is more preferable that the carbonate ester include a combination of a high-viscosity (high dielectric constant) solvent and a low-viscosity solvent. This is because characteristics including, without limitation, a dissociation property of the electrolyte salt and ion mobility improve. The high-viscosity solvent has a specific dielectric constant c that is equal to or higher than 30, for example. Examples of such a high-viscosity solvent include ethylene carbonate and propylene carbonate. The low-viscosity solvent has a viscosity that is equal to or lower than 1 mPa·s, for example. Examples of such a low-viscosity solvent include dimethyl carbonate, ethyl methyl carbonate, and diethyl carbonate.

In particular, it is preferable that the non-aqueous solvent include one or more of unsaturated cyclic carbonate ester, halogenated carbonate ester, sulfonate ester, acid anhydride, a multivalent nitrile compound, a diisocyanate compound, and phosphate ester. This is because chemical stability of the electrolytic solution improves. Note that the content, in the electrolytic solution, of each of the unsaturated cyclic carbonate ester, the halogenated carbonate ester, the sulfonate ester, the acid anhydride, the multivalent nitrile compound, the diisocyanate compound, and the phosphate ester is not particularly limited.

The unsaturated cyclic carbonate ester is cyclic carbonate ester having one or more carbon-carbon unsaturated bonds (carbon-carbon double bonds). Examples of the unsaturated cyclic carbonate ester include vinylene carbonate(1,3-dioxol-2-one), vinyl ethylene carbonate(4-vinyl-1,3-dioxolane-2-one), and methylene ethylene carbonate(4-methylene-1,3-dioxolane-2-one).

The halogenated carbonate ester is a carbonate ester including one or more halogens as constituent elements. The halogenated carbonate ester may be a cyclic halogenated carbonate ester or a chain halogenated carbonate ester, for example. The one or more halogens are each any of fluorine (F), chlorine (Cl), bromine (Br), and iodine (I), for example, although the kinds of halogens are not particularly limited. Examples of the cyclic halogenated carbonate ester include 4-fluoro-1,3-dioxolane-2-one and 4,5-difluoro-1,3-dioxolane-2-one. Examples of the chain halogenated carbonate ester include fluoromethyl methyl carbonate, bis(fluoromethyl) carbonate, and difluoromethyl methyl carbonate.

Examples of the sulfonate ester include monosulfonate ester and disulfonate ester. The monosulfonate ester may be cyclic monosulfonate ester or chain monosulfonate ester. The disulfonate ester may be cyclic disulfonate ester or chain disulfonate ester. Examples of the cyclic monosulfonate ester include 1,3-propane sultone and 1,3-propene sultone.

Examples of the acid anhydride include carboxylic anhydride, disulfonic anhydride, and carboxylic-sulfonic anhydride. Examples of the carboxylic anhydride include succinic anhydride, glutaric anhydride, and maleic anhydride. Examples of the disulfonic anhydride include ethane disulfonic anhydride and propane disulfonic anhydride. Examples of the carboxylic-sulfonic anhydride include sulfobenzoic anhydride, sulfopropionic anhydride, and sulfobutyric anhydride.

The multivalent nitrile compound is a compound having two or more nitrile groups (—CN). Examples of the multivalent nitrile compound include succinonitrile (NC—C₂H₄—CN), glutaronitrile (NC—C₃H₆—CN), adiponitrile (NC—C₄H₈—CN), sebaconitrile (NC—C₈H₁₀—CN), and phthalonitrile (NC—C₆H₄—CN). Examples thereof include (NC—C₈H₁₀—CN) and phthalonitrile (NC—C₆H₄—CN).

The diisocyanate compound is a compound having two isocyanate groups (—NCO). Examples of the diisocyanate compound include OCN—C₆H₁₂—NCO.

Examples of the phosphate ester include trimethyl phosphate, triethyl phosphate, and triallyl phosphate.

The electrolyte salt includes one or more lithium salts, for example. The electrolyte salt may include, in addition to the lithium salt, any salt other than the lithium salt, in one example. Examples of the salt other than the lithium salt include a salt of light metal other than lithium.

Examples of the lithium salt include lithium hexafluorophosphate (LiPF₆), lithium tetrafluoroborate (LiBF₄), lithium bis(fluorosulfonyl)imide (LiN(SO₂F)₂), lithium bis(trifluoromethane sulfonyl)imide (LiN(CF₃SO₂)₂), lithium difluorophosphate (LiPF₂O₂), and lithium fluorophosphate (Li₂PFO₃).

For example, the content of the electrolyte salt is from 0.3 mol/kg to 3.0 mol/kg, although the content of the electrolyte salt is not particularly limited.

The lithium-ion secondary battery operates as follows, for example. Upon charging the lithium-ion secondary battery, lithium ions are extracted from the positive electrode 21, and the extracted lithium ions are inserted into the negative electrode 22 via the electrolytic solution. Upon discharging the lithium-ion secondary battery, lithium ions are extracted from the negative electrode 22, and the extracted lithium ions are inserted into the positive electrode 21 via the electrolytic solution.

The lithium-ion secondary battery is manufactured by the following procedure, for example.

First, the positive electrode active material including the lithium-fluorine-containing compound is mixed with materials including, without limitation, the positive electrode binder and the positive electrode conductor on an as-needed basis to thereby obtain a positive electrode mixture. Thereafter, the positive electrode mixture is dispersed into a solvent such as an organic solvent to thereby obtain a paste positive electrode mixture slurry. Lastly, the positive electrode mixture slurry is applied on both sides of the positive electrode current collector 21A, following which the applied positive electrode mixture slurry is dried to thereby form the positive electrode active material layers 21B. As a result, the positive electrode 21 is fabricated. Thereafter, the positive electrode active material layers 21B may be compression-molded by means of a machine such as a roll pressing machine. In this case, the positive electrode active material layers 21B may be heated. The positive electrode active material layers 21B may be compression-molded a plurality of times.

The negative electrode active material layer 22B is formed on each side of the negative electrode current collector 22A by a procedure similar to the fabrication procedure of the positive electrode 21 described above. Specifically, the negative electrode active material is mixed with materials including, without limitation, the negative electrode positive electrode binder and the negative electrode conductor on an as-needed basis to thereby obtain a negative electrode mixture. Thereafter, the negative electrode mixture is dispersed into a solvent such as an organic solvent to thereby obtain a paste negative electrode mixture slurry. Thereafter, the negative electrode mixture slurry is applied on both sides of the negative electrode current collector 22A, following which the applied negative electrode mixture slurry is dried to thereby form the negative electrode active material layers 22B. As a result, the negative electrode 22 is fabricated. Thereafter, the negative electrode active material layers 22B may be compression-molded.

The electrolyte salt is added to a solvent, following which the dioxane compound is added to the solvent. In this case, the amount of the added dioxane compound is adjusted in such a manner that the content of the dioxane compound in the electrolytic solution becomes the appropriate amount described above.

First, the positive electrode lead 25 is coupled to the positive electrode current collector 21A by a method such as a welding method, and the negative electrode lead 26 is coupled to the negative electrode current collector 22A by a method such as a welding method. Thereafter, the positive electrode 21 and the negative electrode 22 are stacked on each other with the separator 23 interposed therebetween, following which the positive electrode 21, the negative electrode 22, and the separator 23 are wound to thereby form a wound body. Thereafter, the center pin 24 is inserted into the space 20C provided at the winding center of the wound body.

Thereafter, the wound body is interposed between the pair of insulating plates 12 and 13, and the wound body in that state is contained in the battery can 11. In this case, the positive electrode lead 25 is coupled to the safety valve mechanism 15 by a method such as a welding method, and the negative electrode lead 26 is coupled to the battery can 11 by a method such as a welding method. Thereafter, the electrolytic solution is injected into the battery can 11 to thereby impregnate the wound body with the electrolytic solution, causing each of the positive electrode 21, the negative electrode 22, and the separator 23 to be impregnated with the electrolytic solution. As a result, the wound electrode body 20 is formed.

Lastly, the open end of the battery can 11 is crimped by means of the gasket 17 to thereby attach the battery cover 14, the safety valve mechanism 15, and the positive temperature coefficient device 16 to the open end of the battery can 11. Thus, the wound electrode body 20 is sealed in the battery can 11. As a result, the lithium-ion secondary battery is completed.

According to the cylindrical lithium-ion secondary battery: the positive electrode 21 (the positive electrode active material) includes the lithium-fluorine-containing compound; and the electrolytic solution includes the appropriate amount of the dioxane compound (i.e., the dioxane compound having a content that is equal to or greater than 0.1 wt % and equal to or less than 2.0 weight). In this case, because the stable film derived from the dioxane compound is formed on the surface of the positive electrode 21 as described above, the electrolytic solution is less likely to be decomposed on the surface of the positive electrode 21. Accordingly, it is possible to achieve superior battery characteristics.

In particular, the content of the dioxane compound in the electrolytic solution may be equal to or greater than 1.0 wt % and equal to or less than 1.5 wt %. This makes it easier to allow a stable film to be formed on the surface of the positive electrode 21, and it is possible to achieve higher effects accordingly.

Further, the dioxane compound may include 1,3-dioxane. This makes it easier to allow a stable film to be formed on the surface of the positive electrode 21, and it is possible to achieve higher effects accordingly.

Further, the positive electrode active material (the lithium-fluorine-containing compound) may include the lithium-fluorine-containing composite oxide. This makes it further easier to allow the stable film to be formed on the surface of the positive electrode 21, and it is possible to achieve higher effects accordingly. In this case, the other element (M) in the formula (2) may be one or more of titanium, magnesium, aluminum, and zirconium. This makes it further easier to allow a stable film to be formed on the surface of the positive electrode 21, and it is possible to achieve higher effects accordingly.

A description is given next of another lithium-ion secondary battery according to an embodiment of the technology. In the following description, the components of the cylindrical lithium-ion secondary battery described above (refer to FIGS. 1 and 2) are referred to where appropriate.

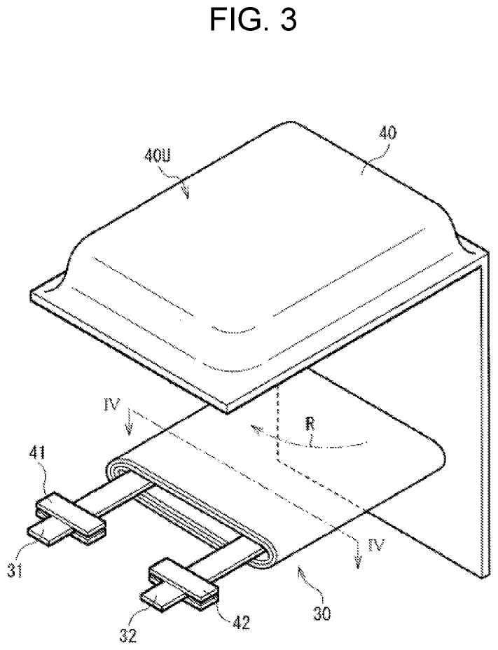

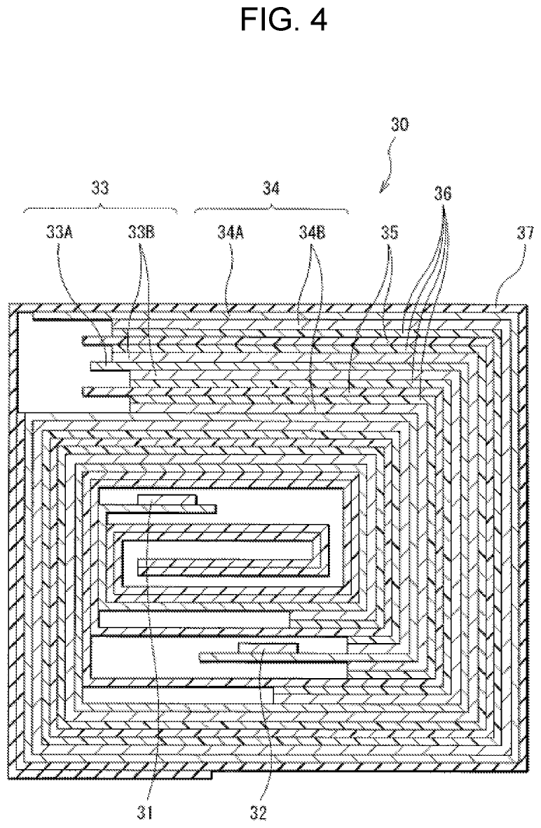

FIG. 3 is a perspective view of a configuration of another lithium-ion secondary battery. FIG. 4 illustrates a sectional configuration of a main part, i.e., a wound electrode body 30, of the lithium-ion secondary battery taken along a line IV-IV illustrated in FIG. 3. Note that FIG. 3 illustrates a state in which the wound electrode body 30 and an outer package member 40 are separated from each other.

Referring to FIG. 3, the lithium-ion secondary battery is of a laminated-film type, for example. The laminated lithium-ion secondary battery is provided with the outer package member 40 that has a film shape and contains the wound electrode body 30, for example. The outer package member 40 has softness or flexibility. The wound electrode body 30 serves as a battery device.

The wound electrode body 30 includes a wound body in which a positive electrode 33 and an negative electrode 34 are stacked with a separator 35 and an electrolyte layer 36 interposed therebetween and in which they are wound, for example. The wound electrode body 30 is protected by means of a protective tape 37. The electrolyte layer 36 is interposed between the positive electrode 33 and the separator 35, and is also interposed between the negative electrode 34 and the separator 35, for example. A positive electrode lead 31 is coupled to the positive electrode 33. A negative electrode lead 32 is coupled to the negative electrode 34.

The positive electrode lead 31 is led out from the inside to the outside of the outer package member 40, for example. The positive electrode lead 31 includes one or more electrically conductive materials such as aluminum. The positive electrode lead 31 has a shape such as a thin-plate shape or a mesh shape.

The negative electrode lead 32 is led out from the inside to the outside of the outer package member 40 in a direction similar to that of the positive electrode lead 31, for example. The negative electrode lead 32 includes one or more electrically conductive materials including, without limitation, copper, nickel, and stainless steel. The negative electrode lead 32 has a shape similar to that of the positive electrode lead 31, for example.

The outer package member 40 is a single film that is foldable in the direction of an arrow R illustrated in FIG. 3, for example. The outer package member 40 has a portion having a depression 40U, for example. The depression 40U is adopted to, for example, contain the wound electrode body 30.

The outer package member 40 is a laminated body or a laminated film including a fusion-bonding layer, a metal layer, and a surface protective layer that are laminated in this order, for example. In a process of manufacturing the lithium-ion secondary battery, for example, the outer package member 40 is so folded that portions of the fusion-bonding layer are opposed to each other and interpose the wound electrode body 30 therebetween. Thereafter, outer edges of the fusion-bonding layer are fusion-bonded to each other. The fusion-bonding layer is a film that includes one or more polymer compounds such as polypropylene. The metal layer is a metal foil that includes one or more materials such as aluminum. The surface protective layer is a film that includes one or more polymer compounds such as nylon. The outer package member 40 may include two laminated films that are adhered to each other by using, for example, an adhesive or the like.

A sealing film 41 is inserted between the outer package member 40 and the positive electrode lead 31, for example. The sealing film 41 is adopted to prevent entry of outside air. A sealing film 42 is inserted between the outer package member 40 and the negative electrode lead 32, for example. The sealing film 42 has a function similar to that of the sealing film 41. The sealing films 41 and 42 each include a material that is adherable to a corresponding one of the positive electrode lead 31 and the negative electrode lead 32. Such a material includes one or more resins such as polyolefin resin. Examples of the polyolefin resin include polyethylene, polypropylene, modified polyethylene, and modified polypropylene.

The positive electrode 33 includes a positive electrode current collector 33A and a positive electrode active material layer 33B, for example. The negative electrode 34 includes a negative electrode current collector 34A and a negative electrode active material layer 34B, for example. The positive electrode current collector 33A, the positive electrode active material layer 33B, the negative electrode current collector 34A, and the negative electrode active material layer 34B respectively have configurations similar to those of the positive electrode current collector 21A, the positive electrode active material layer 21B, the negative electrode current collector 22A, and the negative electrode active material layer 22B, for example. That is, the positive electrode 33 includes, as the positive electrode active material, one or more positive electrode materials (the lithium-fluorine-containing compounds) into which lithium is insertable and from which lithium is extractable. The separator 35 has a configuration similar to that of the separator 23, for example.

The electrolyte layer 36 includes an electrolytic solution and a polymer compound. The electrolytic solution has a configuration similar to that of the electrolytic solution to be used for the cylindrical lithium-ion secondary battery. That is, the electrolytic solution includes an appropriate amount of the dioxane compound.

The electrolyte layer 36 described here is a so-called gel electrolyte, in which the electrolytic solution is held by the polymer compound. This is because high ionic conductivity is obtainable and leakage of the electrolytic solution is prevented. The high ionic conductivity is 1 mS/cm or higher at room temperature, for example. The electrolyte layer 36 may further include one or more other materials such as various additives.

The polymer compound includes a homopolymer, a copolymer, or both, for example. Examples of the homopolymer include polyacrylonitrile, polyvinylidene difluoride, polytetrafluoroethylene, and polyhexafluoropropylene. Examples of the copolymer include a copolymer of vinylidene fluoride and hexafluoropylene.

Regarding the electrolyte layer 36 which is a gel electrolyte, a “solvent” included in the electrolytic solution is a broad concept that encompasses not only a liquid material but also an ion-conductive material that is able to dissociate the electrolyte salt. Accordingly, in the case of using an ion-conductive polymer compound, the polymer compound is also encompassed by the “solvent”.

It should be understood that the electrolytic solution may be used as it is instead of the electrolyte layer 36. In this case, the wound electrode body 30 (the positive electrode 33, the negative electrode 34, and the separator 35) is impregnated with the electrolytic solution.

The lithium-ion secondary battery operates as follows, for example. Upon charging the lithium-ion secondary battery, lithium ions are extracted from the positive electrode 33, and the extracted lithium ions are inserted into the negative electrode 34 via the electrolyte layer 36. Upon discharging the lithium-ion secondary battery, lithium ions are extracted from the negative electrode 34, and the extracted lithium ions are inserted into the positive electrode 33 via the electrolyte layer 36.

The lithium-ion secondary battery including the electrolyte layer 36 is manufactured by any of the following three types of procedures, for example.

### [First Procedure]

First, the positive electrode 33 and the negative electrode 34 are fabricated by procedures similar to those of the positive electrode 21 and the negative electrode 22, respectively. That is, the positive electrode active material layer 33B is formed on each side of the positive electrode current collector 33A upon fabricating the positive electrode 33, and the negative electrode active material layer 34B is formed on each side of the negative electrode current collector 34A upon fabricating the negative electrode 34.

Thereafter, materials including, without limitation, the electrolytic solution, the polymer compound, and a solvent such as an organic solvent are mixed to thereby prepare a precursor solution. Thereafter, the precursor solution is applied on the positive electrode 33, following which the applied precursor solution is dried to thereby form the electrolyte layer 36. The precursor solution is also applied on the negative electrode 34, following which the applied precursor solution is dried to thereby form the electrolyte layer 36. Thereafter, the positive electrode lead 31 is coupled to the positive electrode current collector 33A by a method such as a welding method, and the negative electrode lead 32 is coupled to the negative electrode current collector 34A by a method such as a welding method. Thereafter, the positive electrode 33 and the negative electrode 34 are stacked on each other with the separator 35 interposed therebetween, following which the positive electrode 33, the negative electrode 34, and the separator 35 are wound to thereby form the wound electrode body 30. Thereafter, the protective tape 37 is attached to a surface of the wound electrode body 30.

Lastly, the outer package member 40 is folded in such a manner as to sandwich the wound electrode body 30, following which the outer edges of the outer package member 40 are bonded to each other by a method such as a thermal fusion bonding method. In this case, the sealing film 41 is inserted between the positive electrode lead 31 and the outer package member 40, and the sealing film 42 is inserted between the negative electrode lead 32 and the outer package member 40. Thus, the wound electrode body 30 is sealed in the outer package member 40. As a result, the lithium-ion secondary battery is completed.

### [Second Procedure]

First, the positive electrode 33 and the negative electrode 34 are fabricated. Thereafter, the positive electrode lead 31 is coupled to the positive electrode 33, and the negative electrode lead 32 is coupled to the negative electrode 34. Thereafter, the positive electrode 33 and the negative electrode 34 are stacked on each other with the separator 35 interposed therebetween, following which the positive electrode 33, the negative electrode 34, and the separator 35 are wound to thereby form a wound body. The protective tape 37 is attached to the wound body. Thereafter, the outer package member 40 is folded in such a manner as to sandwich the wound body, following which the outer edges excluding one side of the outer package member 40 are bonded to each other by a method such as a thermal fusion bonding method. Thus, the wound body is contained in the outer package member 40 that has a pouch shape.

Thereafter, the electrolytic solution, the monomers, and a polymerization initiator are mixed to thereby prepare a composition for an electrolyte. The monomers are raw materials of the polymer compound. Another material such as a polymerization inhibitor is mixed on an as-needed basis in addition to the electrolytic solution, the monomers, and the polymerization initiator. Thereafter, the composition for an electrolyte is injected into the outer package member 40 that has a pouch shape, following which the outer package member 40 is sealed by a method such as a thermal fusion bonding method. Lastly, the monomers are thermally polymerized to thereby form the polymer compound. This allows the electrolytic solution to be held by the polymer compound, thereby forming the electrolyte layer 36. Thus, the wound electrode body 30 is sealed in the outer package member 40. As a result, the lithium-ion secondary battery is completed.

### [Third Procedure]

First, a wound body is fabricated and the wound body is contained in the outer package member 40 that has a pouch shape thereafter by a procedure similar to the second procedure, except for using the separator 35 that includes polymer compound layers provided on a base layer. Thereafter, the electrolytic solution is injected into the outer package member 40, following which an opening of the outer package member 40 is sealed by a method such as a thermal fusion bonding method. Lastly, the outer package member 40 is heated with a weight being applied to the outer package member 40 to thereby cause the separator 35 to be closely attached to each of the positive electrode 33 and the negative electrode 34 with the polymer compound layer therebetween. The polymer compound layer is thereby impregnated with the electrolytic solution to be gelated, forming the electrolyte layer 36. Thus, the wound electrode body 30 is sealed in the outer package member 40. As a result, the lithium-ion secondary battery is completed.

The third procedure decreases the likelihood of swelling of the lithium-ion secondary battery as compared with the first procedure. The third procedure also decreases the likelihood of the solvent and the monomers, which are the raw materials of the polymer compound, remaining in the electrolyte layer 36 as compared with the second procedure, allowing for favorable control of a process of forming the polymer compound. Accordingly, it is easier to allow each of the positive electrode 33, the negative electrode 34, and the separator 35 to be closely attached to the electrolyte layer 36 sufficiently.

According to the laminated-film type lithium-ion secondary battery, the positive electrode 33 (the positive electrode active material) includes the lithium-fluorine-containing compound; and the electrolyte layer 36 (the electrolytic solution) includes the appropriate amount of the dioxane compound (i.e., the dioxane compound having a content that is equal to or greater than 0.1 wt % and equal to or less than 2.0 weight). In this case, because a stable film derived from the dioxane compound is formed on the surface of the positive electrode 33 due to a reason similar to that described in relation to the cylindrical lithium-ion secondary battery, the electrolytic solution is less likely to be decomposed on the surface of the positive electrode 33. Accordingly, it is possible to achieve superior battery characteristics.

Other action and effects related to the laminated lithium-ion secondary battery are similar to those related to the cylindrical lithium-ion secondary battery.

### EXAMPLES

A description is given of Examples of the technology below.

### Experiment Examples 1 to 26

The lithium-ion secondary batteries were fabricated and battery characteristics of the respective lithium-ion secondary batteries were evaluated as described below.

The laminated lithium-ion secondary batteries illustrated in FIGS. 3 and 4 were each fabricated by the following procedure.

First, 91 parts by mass of the positive electrode active material, 3 parts by mass of the positive electrode binder (polyvinylidene difluoride), and 6 parts by mass of the positive electrode conductor (graphite) were mixed with each other to thereby obtain a positive electrode mixture.

The kind of positive electrode active material was as represented in Tables 1 and 2. As the positive electrode active material, LiCo_{0.99}Mg_{0.01}O_{1.99}F_{0.01} (LCMOF) being the lithium-fluorine-containing compound (the lithium-fluorine-containing composite oxide), LiCo_{0.99}Mg_{0.01}O₂ (LCMO) not being the lithium-fluorine-containing compound, and LiCo_{0.99}Mg_{0.01}O_{1.99}Cl_{0.01} (LCMOCl) not being the lithium-fluorine-containing compound were used here. The kind of halogen included in the positive electrode active material as a constituent element is indicated in the “Halogen” column in Tables 1 and 2.

A KLL Auger spectrum of magnesium (Mg) included in the positive electrode active material was measured by XPS using Al-Kα rays. As a result, in a case where the positive electrode active material included fluorine as a constituent element, an analysis peak derived from a Mg—F bond was detected in a binding energy range from 300 eV to 310 eV and the analysis peak had the maximum intensity at a binding energy of 306 eV. In contrast, in a case where the positive electrode active material did not include fluorine as a constituent element, an analysis peak derived from a Mg—O bond was detected in a binding energy range from 300 eV to 310 eV and the analysis peak had the maximum intensity at a binding energy of 303 eV. The binding energy corresponding to a position of the peak having the maximum intensity related to each analysis peak is indicated in the “Binding energy (eV)” column in Tables 1 and 2.

Thereafter, the positive electrode mixture was put into an organic solvent (N-methyl-2-pyrrolidone), following which the organic solvent was stirred to thereby obtain a paste positive electrode mixture slurry. Thereafter, the positive electrode mixture slurry was applied on both sides of the positive electrode current collector 33A (a band-shaped aluminum foil having a thickness of 12 μm) by means of a coating device, following which the applied positive electrode mixture slurry was dried to thereby form the positive electrode active material layers 33B. Lastly, the positive electrode active material layers 33B were compression-molded by means of a roll pressing machine. As a result, the positive electrode 33 was fabricated.

First, 95 parts by mass of the negative electrode active material (graphite) and 5 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby obtain a paste negative electrode mixture slurry. Thereafter, the negative electrode mixture slurry was applied on both sides of the negative electrode current collector 34A (a band-shaped copper foil having a thickness of 8 μm) by means of a coating device, following which the applied negative electrode mixture slurry was dried to thereby form the negative electrode active material layers 34B. Lastly, the negative electrode active material layers 34B were compression-molded by means of a roll pressing machine. As a result, the negative electrode 34 was fabricated.

The electrolyte salt (lithium hexafluorophosphate (LiPF₆)) was added to a solvent (ethylene carbonate, propylene carbonate, diethyl carbonate, and propyl propionate), following which the solvent was stirred. Thereafter, the dioxane compound was added to the solvent on an as-needed basis, following which the solvent was stirred. As a result, the electrolytic solution was prepared.

In this case, the mixture ratio (the volume ratio) of ethylene carbonate/propylene carbonate/diethyl carbonate/propyl propionate in the solvent was set to 20:10:30:40, and the content of the electrolyte salt with respect to the solvent was set to 1 mol/kg. The kind of dioxane compound and the content (wt %) of the dioxane compound in the electrolytic solution were as represented in Tables 1 and 2. Here, 1,3-dioxane (DOX) was used as the dioxane compound.

For comparison, sulfonate ester was also used in place of the dioxane compound. The kind of sulfonate ester and the content (wt %) of the sulfonate ester in the electrolytic solution were as represented in Table 2. Here, 1,3-propane sultone (PS) was used as the sulfonate ester.

### (Assembly of Lithium-Ion Secondary Battery)

First, the aluminum positive electrode lead 31 was welded to the positive electrode current collector 33A, and the copper negative electrode lead 32 was welded to the negative electrode current collector 34A. Thereafter, the positive electrode 33 and the negative electrode 34 were stacked on each other with the separator 35 (a fine-porous polyethylene film having a thickness of 9 μm) interposed therebetween to thereby obtain a stacked body. Thereafter, the stacked body was wound in a longitudinal direction, following which the protective tape 37 was attached to the stacked body to thereby form a wound body. Lastly, the outer package member 40 (a nylon film having a thickness of 25 μm as a surface protective layer, an aluminum foil having a thickness of 40 μm as a metal layer, and a polypropylene film having a thickness of 30 μm as a fusion-bonding layer) was folded in such a manner as to sandwich the wound body, following which the outer edges of two sides of the outer package member 40 were thermal fusion bonded to each other. In this case, the sealing film 41 (a polypropylene film) was inserted between the positive electrode lead 31 and the outer package member 40, and the sealing film 42 (a polypropylene film) was inserted between the negative electrode lead 32 and the outer package member 40.

Lastly, the electrolytic solution was injected into the outer package member 40 to thereby impregnate the wound body with the electrolytic solution. Thereafter, the outer edges of one of the remaining sides of the outer package member 40 were thermal-fusion-bonded to each other under a reduced-pressure environment. Thus, the wound electrode body 30 was formed and sealed in the outer package member 40. As a result, the laminated lithium-ion secondary battery was completed.

Evaluation of battery characteristics of the lithium-ion secondary batteries conducted by the following procedure revealed the results represented in Tables 1 and 2. A cyclability characteristic, a swelling characteristic, an electric resistance characteristic, a capacity remaining characteristic, and a capacity restoring characteristic were evaluated here as the battery characteristics.

First, the lithium-ion secondary battery was charged and discharged for one cycle in an ambient temperature environment (a temperature of 23° C.) in order to stabilize a state of the lithium-ion secondary battery. Thereafter, the lithium-ion secondary battery was charged and discharged for one cycle under a low-temperature environment (a temperature of −10° C.), to thereby measure a second-cycle discharge capacity. Thereafter, the lithium-ion secondary battery was repeatedly charged and discharged for 100 cycles under the same environment (a temperature of −10° C.), to thereby measure a 101st-cycle discharge capacity. Lastly, a capacity retention rate (%)=(101st-cycle discharge capacity/second-cycle discharge capacity)×100 was calculated.

Upon charging, the lithium-ion secondary battery was charged with a constant current of 0.7 C until a voltage reached 4.45 V, and was thereafter charged with a constant voltage of 4.45 V until a current reached 0.05 C. That is, the charge voltage was set to 4.45 V here. Upon discharging, the lithium-ion secondary battery was discharged with a constant current of 1 C until the voltage reached 3.0 V. “0.7 C” refers to a value of a current that causes a battery capacity (a theoretical capacity) to be completely discharged in 10/7 hours. “0.05 C” refers to a value of a current that causes the battery capacity to be completely discharged in 20 hours.

The lithium-ion secondary battery whose state was stabilized by the procedure described above was used. First, the lithium-ion secondary battery was charged in an ambient temperature environment (a temperature of 23° C.) until a state of charge (SOC) reached 25%, following which a thickness (a pre-storage thickness (mm)) of the charged lithium-ion secondary battery was measured. Thereafter, the lithium-ion secondary battery was continuously charged under the same environment until the state of charge reached 100%. The charged lithium-ion secondary battery was stored (storing time of 720 hours) under a high-temperature environment (a temperature of 60), following which the thickness (a post-storage thickness (mm)) of the charged lithium-ion secondary battery was measured. Lastly, a thickness variation rate (%)=[(post-storage thickness−pre-storage thickness)/pre-storage thickness]×100 was calculated. Note that charging conditions were similar to those for examining the cyclability characteristic.

The lithium-ion secondary battery whose state was stabilized by the procedure described above was used. First, electric resistance (pre-storage resistance (a)) of the lithium-ion secondary battery in an ambient temperature environment (a temperature of 23° C.) was measured. Thereafter, the lithium-ion secondary battery was stored (storing time of 720 hours) under a high-temperature environment (a temperature of 60° C.), following which the electric resistance (post-storage resistance (a)) of the lithium-ion secondary battery was measured. Lastly, a resistance variation rate (%)=(post-storage resistance/pre-storage resistance)×100 was calculated.

The lithium-ion secondary battery whose state was stabilized by the procedure described above was used. First, the lithium-ion secondary battery was charged and discharged for one cycle in an ambient temperature environment (a temperature of 23° C.) to thereby measure a pre-storage discharge capacity. Thereafter, the lithium-ion secondary battery was charged under the same environment until the state of charge reached 100%. The charged lithium-ion secondary battery was stored (storing time of 720 hours) under a high-temperature environment (a temperature of 60° C.), following which the lithium-ion secondary battery was discharged to thereby measure a post-storage discharge capacity. Lastly, a capacity remaining rate (%)=(post-storage discharge capacity/pre-storage discharge capacity)×100 was calculated. Note that charging and discharging conditions were similar to those for examining the cyclability characteristic.

The lithium ion used to examine the capacity remaining characteristic described above was charged and discharged again for one cycle to thereby measure a fourth-cycle discharge capacity. Thereafter, a capacity restoring rate (%)=(fourth-cycle discharge capacity/second-cycle discharge capacity)×100 was calculated. Note that charging and discharging conditions were similar to those for examining the cyclability characteristic.

TABLE 1

| | Positive electrode | | | | | | | | | |
|---|---|---|---|---|---|---|---|---|---|---|
| | Positive | | | | | Capacity | Thickness | Resistance | Capacity | Capacity |
| | electrode | | Binding | Electrolytic solution | | retention | variation | variation | remaining | restoring |
| Experiment | active | | energy | Dioxane | Content | rate | rate | rate | rate | rate |
| example | material | Halogen | (eV) | compound | (wt %) | (%) | (%) | (%) | (%) | (%) |
| 1 | LCMOF | Fluorine | 306 | — | — | 87 | 55 | 301 | 64 | 78 |
| 2 | LCMOF | Fluorine | 306 | DOX | 0.01 | 86 | 49 | 294 | 66 | 78 |
| 3 | LCMOF | Fluorine | 306 | DOX | 0.1 | 86 | 18 | 256 | 71 | 84 |
| 4 | LCMOF | Fluorine | 306 | DOX | 0.5 | 87 | 8.2 | 202 | 77 | 92 |
| 5 | LCMOF | Fluorine | 306 | DOX | 1.0 | 88 | 7.5 | 204 | 78 | 93 |
| 6 | LCMOF | Fluorine | 306 | DOX | 1.5 | 85 | 7.3 | 213 | 78 | 93 |
| 7 | LCMOF | Fluorine | 306 | DOX | 2.0 | 80 | 6.4 | 218 | 79 | 94 |
| 8 | LCMOF | Fluorine | 306 | DOX | 2.2 | 72 | 6.3 | 225 | 76 | 90 |

TABLE 2

| | Positive electrode | | | | | | | | | | |
|---|---|---|---|---|---|---|---|---|---|---|---|
| | Positive | | | | | | Capacity | Thickness | Resistance | Capacity | Capacity |
| | electrode | | Binding | Electrolytic solution | | | retention | variation | variation | remaining | restoring |
| Experiment | active | | energy | Dioxane | Sulfonate | Content | rate | rate | rate | rate | rate |
| example | material | Halogen | (eV) | compound | ester | (wt % ) | (%) | (%) | (%) | (%) | (%) |
| 9 | LCMO | — | 303 | — | — | — | Non- | Non- | Non- | Non- | Non- |
| | | | | | | | exam- | exam- | exam- | exam- | exam- |
| | | | | | | | inable | inable | inable | inable | inable |
| 10 | LCMO | — | 303 | DOX | — | 0.01 | 82 | 51 | 310 | 63 | 75 |
| 11 | LCMO | — | 303 | DOX | — | 0.1 | 82 | 34 | 296 | 65 | 78 |
| 12 | LCMO | — | 303 | DOX | — | 0.5 | 80 | 28 | 286 | 66 | 79 |
| 13 | LCMO | — | 303 | DOX | — | 1.0 | 78 | 15 | 251 | 72 | 83 |
| 14 | LCMO | — | 303 | DOX | — | 1.5 | 75 | 13 | 254 | 73 | 84 |
| 15 | LCMO | — | 303 | DOX | — | 2.0 | 71 | 12 | 263 | 70 | 84 |
| 16 | LCMO | — | 303 | DOX | — | 2.2 | 61 | 11 | 275 | 65 | 76 |
| 17 | LCMOCl | Chlorine | 303 | — | — | — | 82 | 55 | 290 | 66 | 79 |
| 18 | LCMOCl | Chlorine | 303 | DOX | — | 0.01 | 82 | 53 | 294 | 65 | 78 |
| 19 | LCMOCl | Chlorine | 303 | DOX | — | 0.1 | 77 | 43 | 300 | 64 | 75 |
| 20 | LCMOCl | Chlorine | 303 | DOX | — | 0.5 | 70 | 35 | 320 | 64 | 74 |
| 21 | LCMOCl | Chlorine | 303 | DOX | — | 1.0 | 66 | 20 | 324 | 61 | 73 |
| 22 | LCMOCl | Chlorine | 303 | DOX | — | 1.5 | 65 | 19 | 330 | 59 | 70 |
| 23 | LCMOCl | Chlorine | 303 | DOX | — | 2.0 | 57 | 17 | 345 | 55 | 67 |
| 24 | LCMOCl | Chlorine | 303 | DOX | — | 2.2 | 50 | 15 | 360 | 50 | 60 |
| 25 | LCMOF | Fluorine | 306 | — | PS | 1.0 | 78 | 38 | 316 | 66 | 78 |
| 26 | LCMO | — | 303 | — | PS | 1.0 | 76 | 33 | 320 | 67 | 78 |

As represented in Tables 1 and 2, the battery characteristics, i.e., the cyclability characteristic, the swelling characteristic, the electric resistance characteristic, the capacity remaining characteristic, and the capacity restoring characteristic, varied greatly in accordance with the kind of positive electrode active material and the composition of the electrolytic solution.

In detail, in a case where: the positive electrode active material did not include any halogen as a constituent element; and the electrolytic solution did not include any dioxane compound (Experiment example 9), the lithium-ion secondary battery swelled excessively, making it impossible to examine each of the capacity retention rate, the thickness variation rate, the resistance variation rate, the capacity remaining rate, and the capacity restoring rate.

In a case where: the positive electrode active material did not include any halogen as a constituent element; and the electrolytic solution included the dioxane compound (Experiment examples 10 to 16), it was possible to examine each of the capacity retention rate, the thickness variation rate, the resistance variation rate, the capacity remaining rate, and the capacity restoring rate. However, the capacity retention rate, the capacity remaining rate, and the capacity restoring rate each decreased markedly, and the thickness variation rate and the resistance variation rate each increased markedly, depending on the content of the dioxane compound.

In a case where: the positive electrode active material included a halogen as a constituent element; but the included halogen was chlorine (Experiment examples 17 to 24), tendencies similar to those in the above-described case where the positive electrode active material did not include any halogen as a constituent element (Experiment examples 9 to 16) were observed.

In contrast, in a case where: the positive electrode active material included a halogen as a constituent element; and the included halogen was fluorine (Experiment examples 1 to 8), inclusion of the dioxane compound in the electrolytic solution greatly suppressed a decrease in each of the capacity retention rate, the capacity remaining rate, and the capacity restoring rate and greatly suppressed an increase in each of the thickness variation rate and the resistance variation rate, depending on the content of the dioxane compound.

Specifically, in a case where the content of the dioxane compound fell within an appropriate range, i.e., within a range equal to or greater than 0.1 wt % and equal to or less than 2.0 wt % (Experiment examples 3 to 7), a high capacity retention rate was maintained and the capacity remaining rate and the capacity restoring rate each increased sufficiently while the thickness variation rate and the resistance variation rate each decreased sufficiently, unlike in a case where the content of the dioxane compound fell out of the appropriate range (Experiment examples 2 and 8).

That is, in a case where the content of the dioxane compound fell within the appropriate range, a capacity retention rate of 80% or higher, a capacity remaining rate of 70% or higher, and a capacity restoring rate of 80% or higher were obtained while the thickness variation rate was suppressed to be lower than 20% and the resistance variation rate was suppressed to be lower than 300%. Accordingly, all of the capacity retention rate, the capacity remaining rate, the capacity restoring rate, the thickness variation rate, and the resistance variation rate improved together.

In contrast, in a case where the content of the dioxane compound fell out of the appropriate range, improvement of some of the capacity retention rate, the capacity remaining rate, the capacity restoring rate, the thickness variation rate, and the resistance variation rate caused deterioration of the others. Accordingly, not all of the capacity retention rate, the capacity remaining rate, the capacity restoring rate, the thickness variation rate, and the resistance variation rate improved together. Such a tendency was observed in a case where the positive electrode active material did not include any halogen as a constituent element and in a case where the positive electrode active material included chlorine as a constituent element as well.

The following tendencies were derived from the above with regard to a relationship between the kind of positive electrode active material and the composition of the electrolytic solution.

The kind of positive electrode active material, i.e., presence or absence of a halogen, and the composition of the electrolytic solution, i.e., presence or absence of the dioxane compound, each can influence the battery characteristics. Specifically, in a case where the positive electrode active material does not include any halogen as a constituent element and in a case where the positive electrode active material includes chlorine as a constituent element, inclusion of the dioxane compound in the electrolytic solution negligibly improves the deterioration of the battery characteristics. In contrast, in a case where the positive electrode active material includes fluorine as a constituent element, the inclusion of the dioxane compound in the electrolytic solution greatly suppresses the deterioration of the battery characteristics.

In a case, however, where the positive electrode active material includes fluorine as a constituent element, mere inclusion of the dioxane compound in the electrolytic solution does not greatly suppress the deterioration of the battery characteristics, and the deterioration of the battery characteristics is greatly suppressed only when the content of the dioxane compound is made appropriate.

That is, an inappropriate amount of the dioxane compound results in a trade-off relationship in which improvement of some of the capacity retention rate, the capacity remaining rate, the capacity restoring rate, the thickness variation rate, and the resistance variation rate causes deterioration of the others. Accordingly, it is difficult to improve all of the capacity retention rate, the capacity remaining rate, the capacity restoring rate, the thickness variation rate, and the resistance variation rate together.

In contrast, an appropriate amount of the dioxane compound allows the trade-off relationship to be overcome. Accordingly, it is possible to improve all of the capacity retention rate, the capacity remaining rate, the capacity restoring rate, the thickness variation rate, and the resistance variation rate together.

In particular, in a case where: the positive electrode active material included fluorine as a constituent element; and the content of the dioxane compound fell within the appropriate range (Experiment examples 3 to 7), if the content of the dioxane compound was equal to or greater than 1.0 wt % and equal to or less than 1.5 wt %, there was a tendency that the capacity retention rate, the capacity remaining rate, and the capacity restoring rate each further increased and there was a tendency that the thickness variation rate and the resistance variation rate each further decreased.

It should be understood that, in a case where: the positive electrode active material included a halogen (fluorine) as a constituent element; but the electrolytic solution included sulfonate ester (Experiment example 25), although the thickness variation rate decreased to some extent, the resistance variation rate did not decrease sufficiently, and the capacity retention rate, the capacity remaining rate, and the capacity restoring rate each did not increase sufficiently.

In a case where: the positive electrode active material did not include any halogen as a constituent element; and the electrolytic solution included the sulfonate ester (Experiment example 26), tendencies similar to those in the case where the positive electrode active material included a halogen as a constituent element described above (Experiment example 25) were observed.

That is, in cases where the sulfonate ester was used (Experiment examples 25 and 26), the thickness variation rate and the resistance variation rate each did not decrease sufficiently, and the capacity retention rate, the capacity remaining rate, and the capacity restoring rate each did not increase sufficiently, regardless of whether the positive electrode active material included fluorine as a constituent element.

In contrast, in cases where the dioxane compound was used (Experiment examples 1 to 24), the thickness variation rate and the resistance variation rate each decreased sufficiently, and the capacity retention rate, the capacity remaining rate, and the capacity restoring rate each increased sufficiently, depending on whether the positive electrode active material included fluorine as a constituent element and depending on the content of the dioxane compound.

As can be appreciated from the above, an advantage that all of the capacity retention rate, the capacity remaining rate, the capacity restoring rate, the thickness variation rate, and the resistance variation rate improve together in accordance with the kind of positive electrode active material, i.e., presence or absence of fluorine, and in accordance with the content in the electrolytic solution is not obtainable in the case where the sulfonate ester is used, and is therefore a unique advantage which is obtainable only when the dioxane compound is used.

Based upon the results represented in Tables 1 and 2, in the case where: the positive electrode (the positive electrode active material) included the lithium-fluorine-containing compound; and the electrolytic solution included the appropriate amount of the dioxane compound, i.e., the dioxane compound having a content in the range equal to or greater than 0.1 wt % and equal to or less than 2.0 wt %, all of the cyclability characteristic, the swelling characteristic, the electric resistance characteristic, the capacity remaining characteristic, and the capacity restoring characteristic improved together. Accordingly, superior battery characteristics of the lithium-ion secondary battery were obtained.

Although the technology has been described above with reference to some embodiments and Examples, embodiments of the technology are not limited to those described with reference to the embodiments and the Examples above and are modifiable in a variety of ways.

Specifically, although the description has been given of the cylindrical lithium-ion secondary battery and the laminated lithium-ion secondary battery, this is non-limiting. For example, the lithium-ion secondary battery may be of a prismatic type or a coin type.

Moreover, although the description has been given of a case of the battery device having a wound structure, this is non-limiting. For example, the battery device may have any other structure such as a stacked structure.

It should be understood that the effects described herein are mere examples, and effects of the technology are therefore not limited to those described herein. Accordingly, the technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lithium-ion secondary battery comprising:
a positive electrode that includes a positive electrode active material, the positive electrode active material including lithium (Li) and fluorine (F);
a negative electrode; and
an electrolytic solution that includes a dioxane compound represented by a chemical formula (1), wherein a content of the dioxane compound is from 0.1 weight percent to 2.0 weight percent, 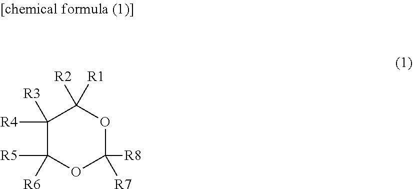
wherein each of R1 to R8 represents at least one of a hydrogen group and a monovalent hydrocarbon group.

2. The lithium-ion secondary battery according to claim 1, wherein the content of the dioxane compound is from 1.0 weight percent to 1.5 weight percent.

3. The lithium-ion secondary battery according to claim 1, wherein the dioxane compound includes 1,3-dioxane.

4. The lithium-ion secondary battery according to claim 2, wherein the dioxane compound includes 1,3-dioxane.

5. The lithium-ion secondary battery according to claim 1, wherein the positive electrode active material includes a lithium-fluorine-containing composite oxide represented by a chemical formula (2),
[chemical formula (1)]
Li_{w}CoₓM_{y}O_{2-z}F_{z} (2)
wherein
M represents at least one of titanium (Ti), vanadium (V), chromium (Cr), manganese (Mn), iron (Fe), nickel (Ni), copper (Cu), sodium (Na), magnesium (Mg), aluminum (Al), silicon (Si), potassium (K), calcium (Ca), zinc (Zn), gallium (Ga), strontium (Sr), yttrium (Y), zirconium (Zr), niobium (Nb), molybdenum (Mo), barium (Ba), lanthanum (La), and tungsten (W), and
w, x, y, and z satisfy 0.8<w<1.2, 0.9<x+y<1.1, 0≤y<0.1, and 0<z<0.05, respectively.

6. The lithium-ion secondary battery according to claim 2, wherein the positive electrode active material includes a lithium-fluorine-containing composite oxide represented by a chemical formula (2),
[chemical formula (2)]
Li_{w}CoₓM_{y}O_{2-z}F_{z} (2)
wherein
M represents at least one of titanium (Ti), vanadium (V), chromium (Cr), manganese (Mn), iron (Fe), nickel (Ni), copper (Cu), sodium (Na), magnesium (Mg), aluminum (Al), silicon (Si), potassium (K), calcium (Ca), zinc (Zn), gallium (Ga), strontium (Sr), yttrium (Y), zirconium (Zr), niobium (Nb), molybdenum (Mo), barium (Ba), lanthanum (La), and tungsten (W), and
w, x, y, and z satisfy 0.8<w<1.2, 0.9<x+y<1.1, 0≤y<0.1, and 0<z<0.05, respectively.

7. The lithium-ion secondary battery according to claim 3, wherein the positive electrode active material includes a lithium-fluorine-containing composite oxide represented by a chemical formula (2),
[chemical formula (2)]
Li_{w}CoₓM_{y}O_{2-z}F_{z} (2)
wherein
M represents at least one of titanium (Ti), vanadium (V), chromium (Cr), manganese (Mn), iron (Fe), nickel (Ni), copper (Cu), sodium (Na), magnesium (Mg), aluminum (Al), silicon (Si), potassium (K), calcium (Ca), zinc (Zn), gallium (Ga), strontium (Sr), yttrium (Y), zirconium (Zr), niobium (Nb), molybdenum (Mo), barium (Ba), lanthanum (La), and tungsten (W), and
w, x, y, and z satisfy 0.8<w<1.2, 0.9<x+y<1.1, 0≤y<0.1, and 0<z<0.05, respectively.

8. The lithium-ion secondary battery according to claim 5, wherein M is at least one of titanium, magnesium, aluminum, and zirconium.

9. The lithium-ion secondary battery according to claim 1, further comprising a separator, wherein the separator is provided between the positive electrode and the negative electrode.

10. The lithium-ion secondary battery according to claim 9, wherein the separator includes at least one of a porous film and a polymer compound layer.

11. The lithium-ion secondary battery according to claim 10, wherein the polymer compound layer includes at least one of a polyvinylidene difluoride and an inorganic particle.

12. The lithium-ion secondary battery according to claim 1, wherein the lithium-ion secondary battery is a cylindrical type battery.

13. The lithium-ion secondary battery according to claim 1, wherein the lithium-ion secondary battery is a laminated film type battery.
